(19) United States
(12) Patent Application Publication
(10) Pub. No.: US 2023/0405983 A1
(43) Pub. Date: Dec. 21, 2023

(54) CELLULOSE BASED MULTILAYER PACKAGING WITH BARRIER PROPERTIES FOR 3D-OBJECTS

(71) Applicant: SOCIETE DES PRODUITS NESTLE S.A., Vevey (CH)

(72) Inventors: JULIEN BRAS, St Martin d'uriage (FR); JULIA CHARDOT, Buc (FR); KARIM MISSOUM, Pusignan (FR); AGATHE MOUREN, La Seyne Sur Mer (FR)

(21) Appl. No.: 18/253,623

(22) PCT Filed: Nov. 17, 2021
(86) PCT No.: PCT/EP2021/081979

§ 371 Date: May 19, 2023

(30) Foreign Application Priority Data
Nov. 20, 2020 (EP) 20208960.3

(51) Int. Cl. B32B 27/10; B32B 23/06; B32B 37/06

(52) U.S. Cl. CPC B32B 27/10; B32B 23/06; B32B 37/06; B32B 2307/7376; B32B 2307/7246; B32B 2307/7244; B32B 2307/718; B32B 37/1018

(57) ABSTRACT

The present invention relates generally to the field of food packaging, in particular food packaging. One embodiment of the present invention relates to a three/dimensional cellulose/based food packaging with excellent barrier properties. For example, the present invention relates to a cellulose-based, multilayer, three-dimensional food packaging comprising a bioplastic layer, a barrier paper layer and a moulded cellulose layer. This cellulose-based, multilayer, three-dimensional food packaging has an oxygen transmission rate (OTR) of less than 30 cc/m²/d (23° C., 50% RH) and a water vapor transmission rate (WVTR) of less than 20 g/m²/d (38° C., 90% RH).

The present invention relates generally to the field of food packaging, in particular food packaging. One embodiment of the present invention relates to a three-dimensional cellulose-based food packaging with excellent barrier properties. For example, the present invention relates to a cellulose-based, multilayer, three-dimensional food packaging comprising a plastic layer, a barrier paper layer and a moulded cellulose layer. This cellulose-based, multilayer, three-dimensional food packaging has an oxygen transmission rate (OTR) of less than 30 cc/m²/d (23° C., 50% RH) and a water vapor transmission rate (WVTR) of less than 20 g/m²/d (38° C., 90% RH).

Packaging of manufactured food products is a vital part of the food industry today as it ensures food safety, preserves food quality and plays an important role in production processes, in brand communication and in digitalization. Indeed, several studies show that for a large part of consumers the packaging of a product is one key aspect that drives the purchase decision.

Plastic packaging is used frequently in the economy and in people's daily lives. It has multiple advantages, such as its 3D shape flexibility, its light weight and its barrier properties. Such a weight reduction contributes to fuel saving and CO 2 reduction during transport, for example. Its barrier properties help to reduce food waste due a positive effect on increasing shelf life. The barrier properties also help to secure food safety.

However, according to the European strategy for plastics in a circular economy, recently published by the European Commission, around 25.8 million tons of plastic waste are generated in Europe every year with less than 30% of such waste being collected for recycling and between 150 000 to 500 000 tons of plastic waste entering the oceans every year.

One of the main problems associated with packaging in general is the generation of packaging waste. According to Eurostat in 2017, 172.6 kg of packaging waste was generated per inhabitant in the EU.

The industry addresses this issue by embracing the circular economy. In line with this, the European Commission has recently communicated a new Circular Economy Action Plan (COMMUNICATION FROM THE COMMISSION TO THE EUROPEAN PARLIAMENT, THE COUNCIL, THE EUROPEAN ECONOMIC AND SOCIAL COMMITTEE AND THE COMMITTEE OF THE REGIONSA new Circular Economy Action Plan For a cleaner and more competitive Europe, Brussels, 11.3.2020). Accordingly, the EU needs to accelerate the transition towards a regenerative growth model that gives back to the planet more than it takes, advance towards keeping its resource consumption within planetary boundaries, and therefore strive to reduce its consumption footprint and double its circular material use rate in the coming decade.

To ensure that plastic waste is reduced, significant efforts are made in the industry and in commerce. Replacing plastics with paper or fibre based solutions in food packaging is one way forward, but not an easy task. A change in packaging material must not compromise consumer safety. The packaging must serve to protect the food, but must also be robust enough to be handled by machines during the production process, and must allow that the food product is presented effectively.

One step towards meeting the challenges mentioned above is to use cellulose-based packaging material. However, cellulose based packaging materials are typically porous (i.e. they have an insufficient gas barrier) and absorb liquids, such as water or oil for example.

For example, in three-dimensional food packaging, one way to address this problem is to use a moulded cellulose layer laminated with a plastic layer. Such multi-layer cellulose-based materials, however, often have a lower cellulose content, may—consequently—be more difficult to recycle and may still have insufficient barrier properties for certain food applications. The necessity to use multiple layers, however, reduces the cellulose content of the packaging material. The recycling of such multilayer packaging materials is—for example—reviewed in Recycling 2018,3, 1-26

Consequently, there is a need in the art for a cellulose-based three-dimensional packaging material that is easy to recycle and that has sufficient barrier properties so that it can be used for food applications.

Any reference to prior art documents in this specification is not to be considered an admission that such prior art is widely known or forms part of the common general knowledge in the field.

The objective of the present invention was to enrich or improve the state of the art and in particular to provide a cellulose-based three-dimensional packaging material that is easy to recycle and that has sufficient oxygen, water nitrogen, and/or carbon dioxide barrier properties so that it can be used for food applications, or to at least provide a useful alternative to solutions existing in the art.

The inventors were surprised to see that the objective of the present invention could be achieved by the subject matter of the independent claims. The dependent claims further develop the idea of the present invention.

Accordingly, the present invention provides a cellulose-based, multilayer, three-dimensional food packaging comprising a bioplastic layer, a barrier paper layer and a moulded cellulose layer. Notably, the cellulose-based, multilayer, three-dimensional food packaging has an oxygen transmission rate (OTR) of less than 30 cc/m²/d (23° C., 50% RH) and a water vapor transmission rate (WVTR) of less than 20 g/m²/d (38° C., 90% RH).

The present invention further provides a method to manufacture such a cellulose-based, multilayer, three-dimensional food packaging.

As used in this specification, the words “comprises”, “comprising”, and similar words, are not to be interpreted in an exclusive or exhaustive sense. In other words, they are intended to mean “including, but not limited to”.

The present inventors have shown that by introducing a paper barrier layer in between a molded cellulose and a bioplastic layer it was possible to manufacture a cellulose-based three-dimensional packaging with sufficiently high oxygen and water vapor barrier properties, so that the packaging can be used for packaging food.

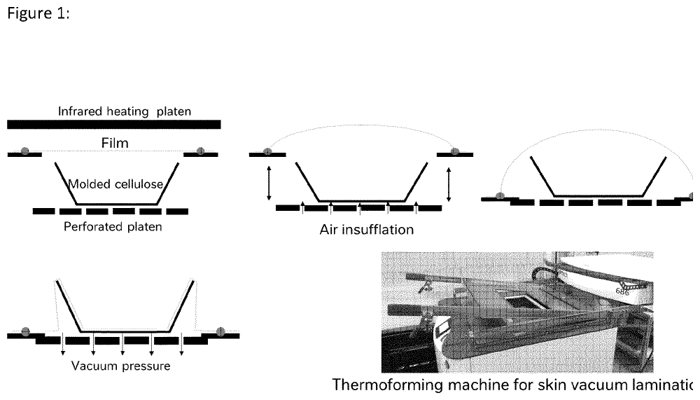

FIG. 1 shows the skin vacuum lamination of bioplastics onto a molded cellulose. This process is used in this invention with putting an intermediate layer of barrier paper between the molded cellulose and the bioplastic film.

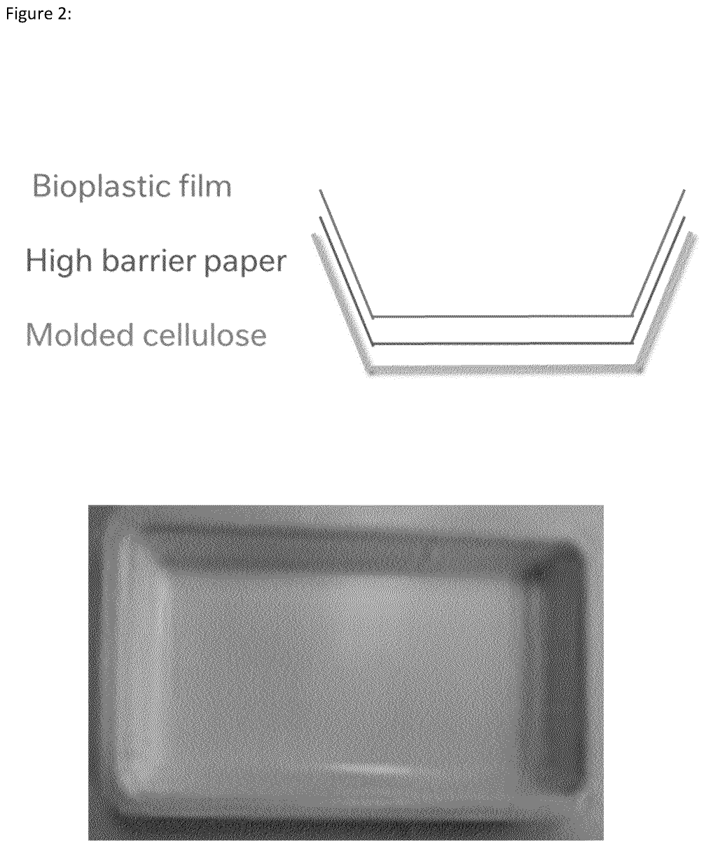

FIG. 2 shows the multilayer strategy proposed in this patent and one example of a final product.

Consequently, the present invention relates in part to a cellulose-based, multilayer, three-dimensional food packaging comprising a bioplastic layer, a barrier paper layer and a moulded cellulose layer.

For the purpose of the present invention, a packaging shall be considered multilayer if it comprises at least three layers.

The term “food” shall comprise for the purpose of the present invention petfood and/or food as defined by Codex Alimentarius. Codex Alimentarius defines the term “food” as any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

A packaging shall be considered as cellulose-based if it contains more than 50 weight-%, more than 60 weight-%, more than 70 weight-%, more than 80 weight-%, more than weight-%, or more than more than 95 weight-% cellulose.

For the purpose of the present invention, a packaging shall be considered as three-dimensional if one dimension is not significantly smaller than the other two dimensions. For example, in a three dimensional packaging one dimension may have a length of not less than about 5% of the other two dimensions, not less than about 5% of the other two dimensions, not less than about 10% of the other two dimensions, not less than about 15% of the other two dimensions, not less than about 20% of the other two dimensions, not less than about 25% of the other two dimensions, not less than about 30% of the other two dimensions, not less than about 35% of the other two dimensions, or not less than about 40% of the other two dimensions.

In accordance with the present invention, the packaging of the present invention has barrier properties that are sufficiently high so that the packaging can be used for packing sensitive food.

3D cellulose-based packaging materials usually have rough surfaces, even much rougher than paper. As a result, the use of large amounts of surface coating material is usually necessary in order to achieve acceptable barrier properties. This coating on 3D packaging is also more complicated than coating on 2D paper and spray technology is classically used favoring a high amount of coating deposited. This may lead to a high plastic content to bring the required gas barrier properties, which in turn may lead to problems during recycling. By introducing a barrier paper between the moulded cellulose layer and the bioplastic layer, the present inventors avoid the use of high amounts of coating on molded pulp, as less coating is needed to coat high barrier paper while delivering the required barrier properties. This results in the usage of at least 50%, at least 60%, at least 70%, at least 80%, or even at least 90% less coating material compared to spray coating moulded cellulose objects without barrier paper layer. In addition, the barrier properties of the packaging are improved. Hence, the cellulose-based, multilayer, three-dimensional food packaging of the present invention may have an oxygen transmission rate (OTR) of less than 30 cc/m²/d (23° C., 50% RH) and a water vapor transmission rate (WVTR) of less than 20 g/m²/d (38° C., 90% RH).

For example, the cellulose-based, multilayer, three-dimensional food packaging of the present invention may have an oxygen transmission rate (OTR) of less than 30 cc/m²/d (23° C., 50% RH), of less than 20 cc/m²/d (23° C., 50% RH), or of less than 10 cc/m²/d (23° C., 50% RH). The cellulose-based, multilayer, three-dimensional food packaging of the present invention may have a water vapor transmission rate (WVTR) of less than 20 g/m²/d (38° C., 90% RH), a water vapor transmission rate (WVTR) of less than 15 g/m²/d (38° C., 90% RH), or a water vapor transmission rate (WVTR) of less than 10 g/m²/d (38° C., 90% RH).

Having the barrier paper layer in between the moulded cellulose layer and the bioplastic layer has—as discussed—the advantage that less plastic coating is needed for coating as the barrier paper has a smoother surface than the moulded cellulose layer. Hence, the cellulose-based, multilayer, three-dimensional food packaging of the present invention may comprise from the inside to the outside a bioplastic layer, a barrier paper layer and a moulded cellulose layer. The inside of the packaging is the side of the packaging that is closest to the food or pet food. In one embodiment of the present invention, the cellulose-based, multilayer, three-dimensional food packaging of the present invention may consist of from the inside to the outside a bioplastic layer, a barrier paper layer and a moulded cellulose layer.

The plastic layer can be petrobased, biobased, biodegradable or not biodegradable. For example, the petrobased non biodegradable polymer layer may be selected from the group consisting of polyolefins (PE, PP), polyesters (PET, PEF) and polystyrene (PS). Bioplastic refers to plastic made from plant or other biological material instead of petroleum. This has the advantage that bioplastic is made from renewable resources. While for the purpose of the present invention any bioplastic may be used, the inventors have obtained very good results with biodegradable polymers. Using biodegradable polymers as bioplastic has the advantage that the biodegradable polymers will be biodegraded with time. Hence, in one embodiment of the present invention, the bioplastic layer may be a biodegradable polymer layer. Further, for example, the biodegradable polymer layer may be selected from the group consisting of polyhydroxyalkanoate (PHA), poly lactic acid (PLA), polytetramethylene succinate (PBS), poly(glycolic acid) PGA or combinations thereof. It is also possible to use biodegradable polymers made from fossil sources such as, for example, polybutylene adipate terephthalate (PBAT).

Accordingly, in the packaging of the present invention the biodegradable polymer layer may have a thickness in the range of 30 to 250 μm, 30 to 200 μm, or 30 to 100 μm.

The barrier paper layer may be selected from the group consisting of dispersion coated paper, extrusion coated paper, or thin organic layer paper, or combinations thereof. For example, the present inventors have used successfully polyvinylidene chloride (PVDC) coated paper or metallized paper.

The inventors have obtained very good results, when the barrier paper layer used in the packaging of the present invention had a basis weight in the range of 15 to 120 g/m², in the range of 30 to 100 g/m², or in the range of 50 to 80 g/m².

Cellulose-based, food packaging layers may be moulded cellulose-based objects, for example moulded cellulose layer. Such three-dimensional moulded cellulose layers are usually prepared from cellulose-based pulps, which are then thermoformed into cellulose-based objects. For example, the cellulose based pulps may contain different types of cellulose pulps. Hence, the three-dimensional moulded cellulose layers may comprise comprises cellulose pulp selected from the group consisting of mechanical pulp, recycled paper pulp, bagasse pulp, annual plant pulp, virgin cellulose pulp, refined cellulose pulp, or a combination thereof. The three-dimensional moulded cellulose layers may also consist of cellulose pulp selected from the group consisting of mechanical pulp, recycled paper pulp, bagasse pulp, annual plant pulp, virgin cellulose pulp, refined cellulose pulp, or a combination thereof.

The inventors have produced a very good prototype using kraft bleached cellulose. Hence, the three-dimensional moulded cellulose layer in accordance with the present invention may comprise or consist of kraft bleached cellulose.

The three-dimensional moulded cellulose layers may also contain a sizing agent. Sizing agents are well-known in the art. Alkylketene dimer (AKD) and alkenyl succinic anhydride (ASA) are typically used as sizing agents. The inventors have obtained particularly good results when alkylketene dimer (AKD) was used as sizing agent. Hence, the cellulose-based object in accordance with the present invention may further comprise AKD.

Hence, in one embodiment of the present invention, the moulded cellulose layer may comprise at least 75 weight-%, at least 85 weight-%, at least 95 weight-%, or at least 99 weight-% cellulose. In one embodiment the moulded cellulose layer may consist of cellulose.

For example, in the three-dimensional food packaging in accordance with the present invention, the moulded cellulose layer may be made with material selected from the group consisting of mechanical pulp, recycled paper pulp, bagasse pulp, annual plant pulp, virgin cellulose pulp, refined cellulose pulp, or combinations thereof and/or may have a basis weight in the range of 100-800 g/m², in the range of 200-700 g/m², or in the range of 300-600 g/m².

In the packaging of the present invention the moulded cellulose layer may be prepared by thermoforming the moulded cellulose into the desired three-dimensional shape. Thermoforming pulp-based products is well-known in the art and, for example, described in Packaging Technology and Science, volume 32, issuel, January 2019, pages 7-22.

The cellulose-based, multilayer, three-dimensional food packaging in accordance with the present invention may be manufactured by any method known in the art. However, the inventors were able to produce such packaging very effectively with a skin vacuum lamination process. Hence, in one embodiment of the present invention, the cellulose-based, multilayer, three-dimensional food packaging is manufactured by a skin vacuum lamination process. The skin vacuum lamination process is well-known in the art, and for example described in EP2082965A1. Accordingly, for the purpose of the present invention a barrier paper may be attached to the inner surface of the three-dimensional moulded cellulose layer. This can be achieved by lamination or by skin vacuum lamination, for example. For skin vacuum lamination the three-dimensional moulded cellulose layer is placed on a support member which allows the application of a vacuum. The bioplastic and the barrier paper is provided in a closed chamber on top of the moulded cellulose layer and a vacuum is applied which attaches the barrier paper and the bioplastic to the surface of the three-dimensional moulded cellulose layer. The barrier paper may be also laminated onto the three-dimensional moulded cellulose with an adhesive. In a closed chamber the bioplastic layer is then provided on top of the barrier paper laminated onto the three-dimensional moulded cellulose layer coated with an adhesive and a vacuum is applied which attaches the bioplastic layer to the surface of the barrier paper.

Optionally, a product may be added to an area of the three-dimensional moulded cellulose layer laminated with barrier paper that is free of adhesive. The bioplastic layer may then be applied on top of the packaging by vacuum skin lamination, so that the bioplastic layer tightly encloses the product and the bioplastic layer is laminated to the top of the barrier paper layer, where there is no product in between barrier paper layer and bioplastic layer.

In one embodiment of the present invention, the bioplastic layer can be peeled off the multilayer packaging prior to recycling. This has the advantage that the bioplastic can be recycled separately and does not enter the paper recycling stream.

The cellulose-based, multilayer, three-dimensional food packaging in accordance with the present invention may be recyclable with the paper stream. The relatively small amounts of bioplastics can be tolerated in the paper recycling stream as the process of paper recycling most often involves breaking down the paper into strands of cellulose, often referred to as pulp or slurry, which is then strained through screens. At this stage, any plastic from multilayer cellulose-based materials is removed.

In one embodiment of the packaging of the present invention, the cellulose-based, multilayer, three-dimensional food packaging is biodegradable and/or compostable. Biodegradable materials can be decomposed by the action of living organisms, usually microbes, into water, carbon dioxide, and biomass. According to the European Commission, for example, biodegradability is the capability of being degraded by biological activity, Pure Applied Chemistry 84 (2), pp. 377-410. The capability of the compostable material to be converted into CO₂ under the action of micro-organisms can be measured with a laboratory standard test method: the EN 14046 (also published as ISO 14855: biodegradability under controlled composting conditions). In order to show complete biodegradability, a biodegradation level of at least 90% must be reached in less than 6 months.

The cellulose-based, multilayer, three-dimensional food packaging may be packaging selected from the group consisting of primary packaging, secondary packaging and tertiary packaging. A primary packaging for a food product may be a packaging for a food product that is in direct contact with the actual food product. A secondary packaging for a food product may be a packaging for a food product that helps secure one or more food products contained in a primary packaging. A secondary packaging is typically used when multiple food products are provided to consumers in a single container. A tertiary packaging for a food product may be a packaging for a food product that helps secure one or more food products contained in a primary packaging and/or in a primary and secondary packaging during transport.

The packaging may be any type of packaging. The inventors propose, in particular, that the packaging may be selected from the group consisting of cups, bottles, trays, capsules, straws, spoons, tips and lids. In a preferred embodiment the cellulose-based, multilayer, three-dimensional food packaging in accordance with the present invention is a food tray, for example, a food tray for frozen food.

The present invention further relates to a method of manufacturing a cellulose-based, multilayer, three-dimensional food packaging in accordance with the present invention comprising the steps of
providing a moulded cellulose layer in a vacuum lamination device with a perforated surface underneath the moulded cellulose layer and a heating element on top of the moulded cellulose layer,
providing a barrier paper layer on top of the moulded cellulose layer and underneath the heating element,
providing a bioplastic layer on top of the barrier paper layer and underneath the heating element, and
applying heat from above and a vacuum from underneath through the perforated surface to form the cellulose-based, multilayer, three-dimensional food packaging.

This process has the advantage that the barrier paper layer and the bioplastic layer can be laminated to the moulded cellulose layer in one step. Adhesives may be used to assist in the lamination and eventual delamination. This process of the present invention may be carried out, for example, in a skin vacuum lamination device. Such devices are commercially available from specialist suppliers.

The heating may be carried out by any heat source. The inventors recommend the use of an infrared heating element as heat source.

The temperature to be used will depend largely on the nature of the bioplastic and/or adhesive, if present, is used. In general, lower temperatures have the advantage that energy can be saved in the manufacturing process.

For example, the heating may be carried out at a temperature in the range of about 100-250° C., of about 100° C.-200° C., or of about 100-170° C.

The temperature to be used will also depend on the time of the lamination process. In general, shorter times allow for faster processing, but typically require higher temperatures. For example, the lamination may be carried out during a time period in the range of about 10-60 s, for example in the range of about 20-40 s.

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### Examples

Materials:

The molded cellulose tray is made of bleached kraft pulp after refining and supplied by a commercial partner.

Two barrier papers were tested: BarPap1 is a metallized paper of about 60 gsm developed for its barrier properties, BarPap2 is a PVDC coated paper used in food packaging industry of about 70 g/m².

The bioplastic is an Ecovio grade (BASF) with a thickness of 50 μm provided by a converter and obtained by extrusion casting.

Methods:

The molded cellulose products were laminated with skin vacuum lamination process. The used machine was the vacuum forming machine 686 from Formtech. The machine had 6 heating zones, and the power level could be set from 0% to 100%. The maximum power was 300 W for outer platen and 250 W for inner ones. The heating time was about 5 s. Molded cellulose materials have been preheated and the temperature of the film was recorded with an infrared thermometer just before vacuum application.

The water vapor transmission rate (WVTR) was measured following ISO 2528 used for flat packaging material. The sample was cut to obtain a flat disc of 90 mm diameter. Approximately 20 g of desiccant (dried silica gel) was placed into an aluminum clean dish. The cut sample was placed on the dish with the barrier face upwards. The dish was placed onto the aluminum device. Molten wax has been poured into the annular cavity between the cover template and the rim of the dish and the wax has been left to solidify. The exposed material surface of a sealed sample was 50 cm². After drying, the sample was weighed before being placed into climate chamber at 23° C. and 85% relative humidity.

The oxygen transmission rate was measured following the standard DIN 53338-5 with an adapted fluorescent method.

Results:

The results are summarized in the table below

| | | | Molded | Molded |
|---|---|---|---|---|
| | | Molded | pulp/ | pulp/ |
| | Molded | pulp/ | BarPap1/ | BarPap2/ |
| | pulp | Bioplastics | Bioplastics | Bioplastics |
| OTR cc/m²/d | 3000 | 620 | 6 | 15 |
| (23° C., 50% RH) | | | | |
| WVTR g/m²/d | 1000 | 30 | 0.298 | 0.149 |
| (23° C., 85% RH) | | | | |

This table shows the positive impact on the gas barrier that is achieved by adding the interlayer of a barrier paper in between the molded pulp and the bioplastic.

1. Cellulose-based, multilayer, three-dimensional food packaging comprising a plastic layer, a barrier paper layer and a moulded cellulose layer, wherein the cellulose-based, multilayer, three-dimensional food packaging has an oxygen transmission rate (OTR) of less than 30 cc/m²/d (23° C., 50% RH) and a water vapor transmission rate (WVTR) of less than 20 g/m²/d (38° C., 90% RH)

2. Cellulose-based, multilayer, three-dimensional food packaging in accordance with claim 1, wherein the cellulose-based, multilayer, three-dimensional food packaging comprises from the inside to the outside a plastic layer, a barrier paper layer and a moulded cellulose layer.

3. Cellulose-based, multilayer, three-dimensional food packaging in accordance with claim 1, wherein the plastic layer is selected from the group consisting of biodegradable polymers, for example, PHA, PLA, PBAT, PBS, PGA and combinations thereof and has a thickness in the range of 30 to 250 μm.

4. Cellulose-based, multilayer, three-dimensional food packaging in accordance with claim 1, wherein the barrier paper layer is selected from the group consisting of dispersion coated paper, extrusion coated paper, or thin organic layer paper, and combinations thereof and has a basis weight in the range of 15 to 120 gsm.

5. Cellulose-based, multilayer, three-dimensional food packaging in accordance with claim 1, wherein the moulded cellulose layer is made with material selected from the group consisting of, mechanical pulp, recycled paper pulp, bagasse pulp, annual plant pulp, virgin cellulose pulp, refined cellulose pulp, and combinations thereof and has a basis weight in the range of 100-800 gsm.

6. Cellulose-based, multilayer, three-dimensional food packaging in accordance with claim 1, wherein the moulded cellulose layer is prepared by thermoforming the moulded cellulose into the desired three-dimensional shape.

7. Cellulose-based, multilayer, three-dimensional food packaging in accordance with claim 1, wherein the cellulose-based, multilayer, three-dimensional food packaging is manufactured by a skin vacuum lamination process.

8. Cellulose-based, multilayer, three-dimensional food packaging in accordance with claim 1, wherein the cellulose-based, multilayer, three-dimensional food packaging is recyclable with the paper stream.

9. Cellulose-based, multilayer, three-dimensional food packaging in accordance with claim 1, wherein the cellulose-based, multilayer, three-dimensional food packaging is biodegradable.

10. Cellulose-based, multilayer, three-dimensional food packaging in accordance with claim 1, wherein the packaging is selected from the group consisting of primary packaging, secondary packaging and tertiary packaging.

11. Cellulose-based, multilayer, three-dimensional food packaging in accordance with claim 1, wherein the packaging is selected from the group consisting of cups, bottles, trays, capsules, spoon, tips and lids.

12. Cellulose-based, multilayer, three-dimensional food packaging in accordance with claim 1, wherein the cellulose-based, multilayer, three-dimensional food packaging is a food tray.

13. Method of manufacturing a cellulose-based, multilayer, three-dimensional food packaging comprising the steps of
providing a moulded cellulose layer in a vacuum lamination device with a perforated surface underneath the moulded cellulose layer and a heating element on top of the moulded cellulose layer,
providing a barrier paper layer on top of the moulded cellulose layer and underneath the heating element,
providing a bioplastic layer on top of the barrier paper layer and underneath the heating element, and
applying heat from above and a vacuum from underneath through the perforated surface to form the cellulose-based, multilayer, three-dimensional food packaging.

14. Method in accordance with claim 13, wherein the heating is carried out with an infrared heating element at a temperature in the range of about 100-250° C.

15. Method in accordance with claim 13, wherein the lamination is carried out during a time period in the range of about 10-60 s.
